(19) United States
(12) Patent Application Publication
(10) Pub. No.: US 2009/0153018 A1
(43) Pub. Date: Jun. 18, 2009

(54) PLASMA DISPLAY PANEL

(75) Inventors: Taro Naoi, Yamanashi (JP); Shinsuke Yoshida, Yamanashi (JP); Hai Lin, Yamanashi (JP)

Correspondence Address: ARENT FOX LLP, 1050 CONNECTICUT AVENUE, N.W., SUITE 400, WASHINGTON, DC, 20036, US

(73) Assignee: PIONEER CORPORATION, Tokyo (JP)

(21) Appl. No.: 12/180,128

(22) Filed: Jul. 25, 2008

(30) Foreign Application Priority Data
Dec. 13, 2007 (JP) 2007-321652

(51) Int. Cl. H01J 1/62

(52) U.S. Cl. 313/486

(57) ABSTRACT

Powder of a crystal body is disposed in positions respectively facing the discharge cells formed in the discharge space S defined between the front glass substrate and the back glass substrate of a PDP. The crystal body is included among an MgO crystal body having properties of causing CL (and PL) emission having a peak within a 200-nm to 300-nm wavelength range upon excitation by ultraviolet rays, and has properties of having a higher intensity of light emission caused by 146-nm wavelength ultraviolet light than the intensity of light emission caused by 172-nm wavelength ultraviolet light.

### BACKGROUND OF THE INVENTION

1. FIELD OF THE INVENTION

This invention relates to the structure of plasma display panels.

The present application claims priority from Japanese Application No. 2007-321652, the disclosure of which is incorporated herein by reference.

2. DESCRIPTION OF THE RELATED ART

In general, a surface-discharge-type AC plasma display panel (hereinafter referred to as “PDP”) comprises two glass substrates facing each other across a discharge space filled with a discharge gas. Row electrode pairs each extending in the row direction are arranged in the column direction on one of the glass substrates. Column electrodes each extending in the column direction are arranged in the row direction on the other glass substrate. Unit light emission areas (discharge cells) are respectively formed in matrix arrangement at areas in the discharge space corresponding to the intersections of the row electrode pairs and the column electrodes. In addition, a dielectric layer is deposited so as to overlie the row electrodes or the column electrodes. In turn, MgO (magnesium oxide) films are deposited on portions of the dielectric layer facing the discharge space. The MgO film has the function of protecting the dielectric layer and the function of emitting secondary electrons into the unit light emission areas.

Some conventional PDPs structured as described above are provided with a crystalline MgO layer facing the discharge space between the opposing front and back glass substrates. The crystalline MgO layer is formed of a classified crystal powder which is extracted from the powder of a magnesium oxide crystal body causing a CL (Cathode Luminescence) emission having a peak within a wavelength range of 200 nm to 300 nm upon excitation by an electron beam and has a particle-size distribution in which the percentage of the crystal of a predetermined particle diameter or larger is of a predetermined value or more.

A conventional PDP structured as described above is disclosed in Japan Unexamined Patent Publication No. 2006-147417, for example.

In the conventional PDP, the crystalline MgO layer facing the discharge space includes an MgO crystal body causing a CL emission having a peak within a wavelength range of 200 nm to 300 nm upon excitation by an electron beam. Because of this, the discharge characteristics such as those relating to discharge delay and discharge probability in the PDP are improved. Thus, the PDP is capable of having satisfactory discharge characteristics. Further, because the powder of the MgO crystal body forming the crystalline MgO layer undergoes the classification process in the course of manufacturing for the PDP, the MgO crystal powder has a particle-size distribution in which the ratio of the crystal body of a predetermined particle diameter or larger is of a predetermined value or higher. In consequence, the discharge characteristics of the PDP, relating to discharge delay, can be improved.

However, an improvement in the display quality of PDPs is increasingly required on the market year in, year out. To respond to this, a further improvement in the discharge delay characteristics in PDPs has been strongly requested.

### SUMMARY OF THE INVENTION

It is a technical object of the present invention is to respond to the requests relating to the conventional PDPs as described above.

To attain this object, the present invention provides a PDP which comprises a front substrate and a back substrate facing each other across a discharge space; row electrode pairs and column electrodes arranged between the front substrate and the back substrate to form unit light emission areas in positions in the discharge space respectively corresponding to intersections between the row electrode pairs and the column electrodes; and a dielectric layer covering the row electrode pairs. In the PDP, powder of a crystal body is disposed in positions facing the unit light emission areas. The powder of the crystal body is included among a magnesium oxide crystal body having properties of causing cathode luminescence emission having a peak within a wavelength range of 200 nm to 300 nm upon excitation by ultraviolet rays, and has properties of having a higher intensity of light emission caused by ultraviolet light at 146-nm wavelength than an intensity of light emission caused by ultraviolet light at 172-nm wavelength.

In a PDP of an exemplary embodiment of the present invention, powder of a crystal body is disposed in positions facing discharge cells formed in the discharge space defined between the front glass substrate and the back glass substrate. The powder of the crystal body is included among an MgO crystal body having properties of causing cathode luminescence (photoluminescence) emission having a peak within a 200-nm to 300-nm wavelength range upon excitation by ultraviolet rays, and has properties of having a higher intensity of light emission caused by 146-nm wavelength ultraviolet light than the intensity of light emission caused by 172-nm wavelength ultraviolet light.

In the PDP according to the embodiment, the powder of MgO crystal body having the properties of having a higher intensity of light emission caused by 146-nm wavelength ultraviolet light than that of light emission caused by 172-nm wavelength ultraviolet light is disposed in positions facing the discharge cells formed in the discharge space. As a result, the primary electron emission properties are enhanced by an increase in primary electrons emitted into the discharge cells upon excitation by 146-nm wavelength ultraviolet light. In consequence, the PDP can be significantly improved in its discharge delay characteristics in the PDP operation as compared with those in conventional PDPs.

In the PDP of the embodiment, the powder of the crystal body preferably has 130 percent or higher of an emission intensity ratio of the intensity of light emission caused by the 146-nm wavelength ultraviolet light to the intensity of light emission caused by the 172-nm wavelength ultraviolet light.

As a result, a further improvement in the discharge delay characteristics in the PDP operation can be achieved.

Further, in the PDP of the embodiment, the powder of the crystal body preferably has properties of causing cathode luminescence emission having a peak within a wavelength range of 230 nm to 250 nm, and preferably includes a single-crystal body obtained by performing vapor-phase oxidization on magnesium steam generated by heating magnesium.

In the PDP of the embodiment, the mounting manner for disposing the powder of MgO crystal body having the properties of having a higher intensity of light emission caused by the 146-nm ultraviolet light than that of light emission caused by the 172-nm ultraviolet light include can be selected. For example, a crystalline magnesium oxide layer including the powder of the crystal body may be deposited on the dielectric layer and the powder of the crystal body of the crystalline magnesium oxide layer may be exposed to the unit light emission areas. Alternatively, the powder of the crystal body may be included in phosphor layers deposited on the back glass substrate in the discharge cells. In either case, a significant improvement in the discharge delay characteristic in the PDP operation can be achieved.

### BRIEF DESCRIPTION OF THE DRAWINGS

These and other objects and advantages of the present invention will become clear from the following description with reference to the accompanying drawings, wherein:

FIG. 1 is a front view illustrating an example of a PDP according to the present invention;

FIG. 2 is a sectional view taken along the V-V line in FIG. 1;

FIG. 3 is a sectional view taken along the W-W line in FIG. 1;

FIG. 4 is a sectional view illustrating a crystalline MgO layer formed on a thin-film magnesium layer in the example;

FIG. 5 is a sectional view illustrating a thin-film magnesium layer formed on a crystalline MgO layer in the example;

FIG. 6 is an SEM photograph of an MgO single-crystal body having a cubic single-crystal structure;

FIG. 7 is an SEM photograph of an MgO single-crystal body having a cubic polycrystal structure;

FIG. 8 is a graph showing the relationship between the particle diameter of an MgO single-crystal body and the wavelengths of CL emission in the example;

FIG. 9 is a graph showing the relationship between the particle diameter of the MgO single-crystal body and the intensity of the 235-nm CL emission in the example;

FIG. 10 is a graph showing the state of the wavelength of the CL emission from an MgO layer formed by vapor deposition;

FIG. 11 is a graph showing the relationship between the discharge delay and the peak intensity of the 235-nm CL emission from MgO single crystal body;

FIG. 12 is a graph showing the relationship between the 172-nm emission intensity and the discharge delay;

FIG. 13 is a graph showing the relationship between the 146-nm emission intensity and the discharge delay;

FIG. 14 is a diagram illustrating the principle of CL emission;

FIG. 15 is a graph showing the relationship between the emission intensity ratio and the discharge delay;

FIG. 16 is a table showing the 146-nm emission intensity and the 172-nm emission intensity of the MgO crystal body in FIG. 15, the values of the ratio between the 146-nm emission intensity and the 172-nm emission intensity, and the discharge delay time of a PDP;

FIG. 17 is a graph showing the spectra when the MgO crystal body is irradiated by use of a 172-nm ultraviolet lamp; and

FIG. 18 is a graph showing the spectra when the MgO crystal body is irradiated by use of a 146-nm ultraviolet lamp.

### DETAILED DESCRIPTION OF THE PREFERRED EMBODIMENT

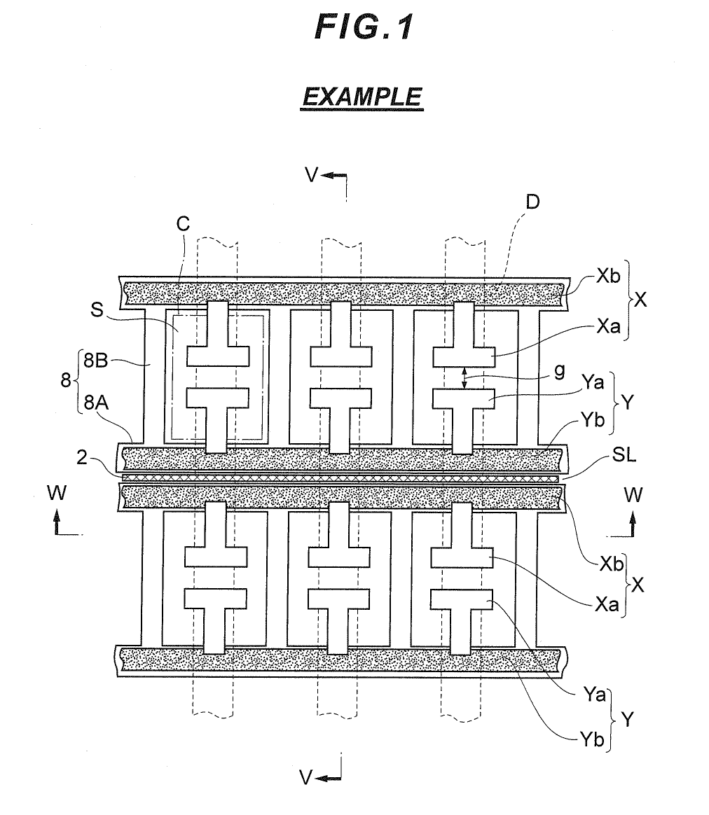

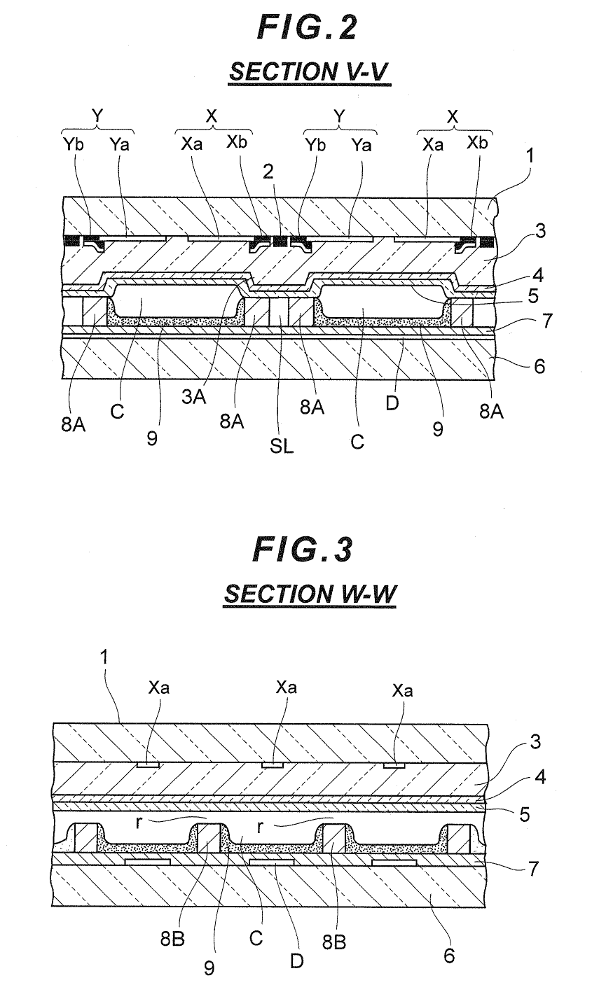

FIGS. 1 to 3 illustrate an example of an embodiment of a PDP according to the present invention. FIG. 1 is a schematic front view of the PDP in the example. FIG. 2 is a sectional view taken along the V-V line in FIG. 1. FIG. 3 is a sectional view taken along the W-W line in FIG. 1.

The PDP in FIGS. 1 to 3 has a plurality of row electrode pairs (X, Y) arranged in parallel on the rear-facing face (the face facing toward the rear of the PDP) of a front glass substrate 1 serving as the display surface. Each row electrode pair (X, Y) extends in the row direction of the front glass substrate 1 (the right-left direction in FIG. 1).

A row electrode X is composed of T-shaped transparent electrodes Xa formed of a transparent conductive film made of ITO or the like, and a bus electrode Xb formed of a metal film. The bus electrode Xb extends in the row direction of the front glass substrate 1. The narrow proximal end (corresponding to the foot of the “T”) of each transparent electrode Xa is connected to the bus electrode Xb.

Likewise, a row electrode Y is composed of T-shaped transparent electrodes Ya formed of a transparent conductive film made of ITO or the like, and a bus electrode Yb formed of a metal film. The bus electrode Yb extends in the row direction of the front glass substrate 1. The narrow proximal end of each transparent electrode Ya is connected to the bus electrode Yb.

The row electrodes X and Y are arranged in alternate positions in the column direction of the front glass substrate 1 (the vertical direction in FIG. 1). In each row electrode pair (X, Y), the transparent electrodes Xa and Ya are regularly spaced along the facing bus electrodes Xb and Yb and each extends out toward its counterpart in the row electrode pair, so that the wide distal ends (corresponding to the head of the “T”) of the respective transparent electrodes Xa and Ya face each other on either side of a discharge gap g having a required width.

Black- or dark-colored light absorption layers (light-shield layers) 2 are further formed on the rear-facing face of the front glass substrate 1. Each of the light absorption layers 2 extends in the row direction along and between the back-to-back bus electrodes Xb and Yb of the row electrode pairs (X, Y) adjacent to each other in the column direction.

A dielectric layer 3 is formed on the rear-facing face of the front glass substrate 1 so as to cover the row electrode pairs (X, Y), and has additional dielectric layers 3A each formed on a portion of the rear-facing face thereof, opposite to the back-to-back bus electrodes Xb, Yb of the adjacent row electrode pairs (X, Y) and to the area between the bus electrodes Xb, Yb. Each of the additional dielectric layers 3A projects from the dielectric layer 3 toward the rear of the PDP and extends in parallel to the back-to-back bus electrodes Xb, Yb.

The rear-facing faces of the dielectric layer 3 and the additional dielectric layers 3A are entirely covered by a magnesium oxide layer 4 of thin film (hereinafter referred to as “thin-film MgO layer 4”) formed by vapor deposition or sputtering.

A magnesium oxide layer 5 including a magnesium oxide crystal body (hereinafter referred to as “crystalline MgO layer 5”) is formed on the rear-facing face of the thin-film MgO layer 4. The MgO crystal body included in the crystalline MgO layer 5 has the properties of causing photo-luminescence emission (hereinafter referred to as “PL emission”) and cathode-luminescence emission (hereinafter referred to as “CL emission”) having a peak within a wavelength range from 200 nm to 300 nm (particularly, from 230 nm to 250 nm, around 235 nm) on excitation by ultraviolet rays, as described later in detail.

The structure of the crystalline MgO layer 5 will be described later in detail.

The crystalline MgO layer 5 is formed on the entire rear face of the thin-film MgO layer 4 or a part of the rear face thereof, for example, the part facing each discharge cell described later (in the example shown in FIGS. 1 to 3, the crystalline MgO layer 5 is formed on the entire rear face of the thin-film MgO layer 4).

The front glass substrate 1 is disposed parallel to a back glass substrate 6. Column electrodes D are arranged in parallel at predetermined intervals on the front-facing face (the face facing toward the display surface) of the back glass substrate 6. Each of the column electrodes D extends in a direction at right angles to the row electrode pair (X, Y) (i.e. the column direction) along a strip opposite to the paired transparent electrodes Xa and Ya of each row electrode pair (X, Y).

On the front-facing face of the back glass substrate 6, a white column-electrode protective layer (dielectric layer) 7 covers the column electrodes D, and in turn partition wall units 8 are formed on the column-electrode protective layer 7.

Each of the partition wall units 8 is formed in an approximate ladder shape made up of a pair of transverse walls 8A and a plurality of vertical walls 8B. The transverse walls 8A respectively extend in the row direction on portions of the column-electrode protective layer 7 opposite the bus electrodes Xb, Yb of each row electrode pair (X, Y). Each of the vertical walls 8B extends between the pair of transverse walls 8A in the column direction on a portion of the column-electrode protective layer 7 between the adjacent column electrodes D. The partition wall units 8 are regularly arranged in the column direction in such a manner as to form an interstice SL extending in the row direction between the back-to-back transverse walls 8A of the adjacent partition wall units 8.

The ladder-shaped partition wall units 8 partition the discharge space S defined between the front glass substrate 1 and the back glass substrate 6 into quadrangles to form discharge cells C. Each of the discharge cells C corresponds to the paired transparent electrodes Xa and Ya of each row electrode pair (X, Y).

In each discharge cell C, a phosphor layer 9 covers the five faces facing the discharge space S: the side faces of the transverse walls 8A and the vertical walls 8B of the partition wall unit 8 and the face of the column-electrode protective layer 7. The three primary colors, red, green and blue, are individually applied to the phosphor layers 9 such that the red, green and blue discharge cells C are arranged in order in the row direction.

The crystalline MgO layer 5 covering the additional dielectric layers 3A (or the thin-film MgO layer 4 in the case where the crystalline MgO layer 5 is formed on each portion of the rear-facing face of the thin-film MgO layer 4 facing the discharge cell C) is in contact with the front-facing face of the transverse walls 8A of the partition wall unit 8 (see FIG. 2), so that each of the additional dielectric layers 3A blocks off the discharge cell C and the interstice SL from each other. However, the crystalline MgO layer 5 is out of contact with the front-facing face of the vertical walls 8B (see FIG. 3). As a result, a clearance r is formed between the crystalline MgO layer 5 and each of the vertical walls 8B, so that the adjacent discharge cells C in the row direction communicate with each other by means of the clearance r.

The discharge space S is filled with a discharge gas including xenon.

Next, the structure of the crystalline MgO layer 5 will be described.

For the buildup of the crystalline MgO layer 5, a method such as a spraying technique or an electrostatic coating technique is used so that the MgO crystal body, which has the properties of causing CL (and PL) emission having a peak within a wavelength range from 200 nm to 300 nm (particularly, from 230 nm to 250 nm, around 235 nm) on excitation by ultraviolet rays as described earlier, is cause to adhere to the rear-facing surface of the thin-film MgO layer 4 covering the dielectric layer 3 and the additional dielectric layers 3A.

The example describes the case in which the crystalline MgO layer 5 is deposited on the rear-facing face of the thin-film MgO layer 4 that has been formed on the rear-facing faces of the dielectric layer 3 and the additional dielectric layers 3A. However, a crystalline MgO layer 5 may be formed on the rear-facing faces of the dielectric layer 3 and the additional dielectric layers 3A and then a thin-film MgO layer 4 may be formed on the rear-facing face of the crystalline MgO layer 5.

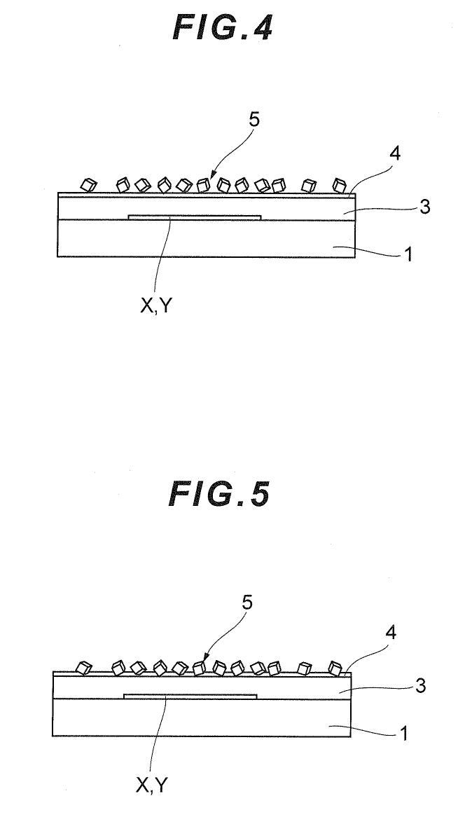

FIG. 4 illustrates the state when the thin-film MgO layer 4 is first formed on the rear-facing face of the dielectric layer 3 and then an MgO crystal body is affixed to the rear-facing face of the thin-film MgO layer 4 to form the crystalline MgO layer 5 by use of a method such as a spraying technique or an electrostatic coating technique.

FIG. 5 illustrates the state when the MgO crystal body is affixed to the rear-facing face of the dielectric layer 3 to form the crystalline MgO layer 5 by use of a method such as a spraying technique or an electrostatic coating technique, and then the thin-film MgO layer 4 is formed. In this case, the MgO crystal body is also exposed to the discharge space.

The crystalline MgO layer 5 of the PDP is formed by use of the following materials and method.

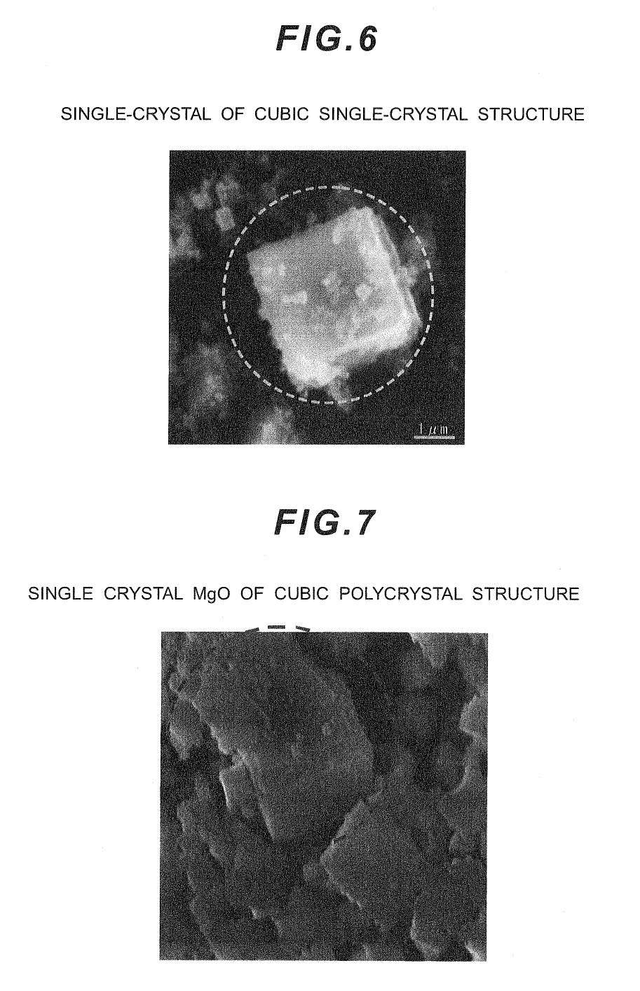

Examples of an MgO crystal body having properties of causing CL (and PL) emission having a peak within a wavelength range from 200 nm to 300 nm (particularly, from 230 nm to 250 nm, around 235 nm) upon excitation by ultraviolet rays, which is used as the material for forming the crystalline MgO layer 5, include a single-crystal body of magnesium obtained by performing vapor-phase oxidization on magnesium steam generated by heating magnesium (the magnesium single-crystal body is hereinafter referred to as “a vapor-phase MgO single-crystal body”). Examples of the vapor-phase MgO single-crystal body includes an MgO single-crystal body having a cubic single-crystal structure as illustrated in the SEM photograph in FIG. 6, and an MgO single-crystal body having a structure of cubic crystal bodies fitted to each other (i.e. a cubic polycrystal structure) as illustrated in the SEM photograph in FIG. 7.

The CL (and PL) emission intensity caused by ultraviolet light (resonance line) at a wavelength of 146 nm, which is hereinafter referred to as “146-nm emission intensity”, is greater than the CL (and PL) emission intensity caused by ultraviolet light (molecular beam) at a wavelength of 172 nm, which is hereinafter referred to as “172-nm emission intensity”. Among such MgO crystal bodies that have the properties of causing CL (and PL) emission having a peak within the 200-nm to 300-nm wavelength range upon excitation by ultraviolet rays as described above, an MgO crystal body having a predetermined ratio or higher of the 146-nm emission intensity to the 172-nm emission intensity, which is hereinafter referred to as “emission intensity ratio” is included in the MgO crystal body having the properties of causing CL (and PL) emission having a peak within a wavelength range from 200 nm to 300 nm (particularly, from 230 nm to 250 nm, around 235 nm) upon excitation by ultraviolet rays, which is used as the material for forming the crystalline MgO layer 5.

In the example, the MgO crystal body used for forming the crystalline MgO layer 5 includes powder of the MgO crystal body having an emission intensity ratio of 130 percents or higher ((146-nm emission intensity)/(172-nm emission intensity)≧1.30).

Next, the function of the crystalline MgO layer 5 in the operation of the PDP will be described.

In the above-mentioned PDP, a reset discharge, an address discharge and a sustaining discharge are produced in the discharge cells C for generating an image.

When the reset discharge and the address discharge are produced in the discharge cells C, the priming effect caused by the reset discharge and the address discharge is maintained for a long duration by disposing the crystalline MgO layer 5 so as to face each of the discharge cells C, leading to a fast response from the sustaining discharge as well as from the address discharge. In consequence, the discharge characteristics of the PDP such as those relating to the discharge delay and the discharge probability are improved.

In addition, as described later, the MgO crystal body used for forming the crystalline MgO layer 5 includes the MgO crystal body powder having 130 percent or higher of the ratio of the 146-nm emission intensity to the 172-nm emission intensity. As a result, the PDP is enhanced in its primary electron emission properties by an increased amount of primary electrons emitted into the discharge cells C, resulting in a significant improvement in the discharge delay in the operation of the PDP as compared with the case of a conventional PDP.

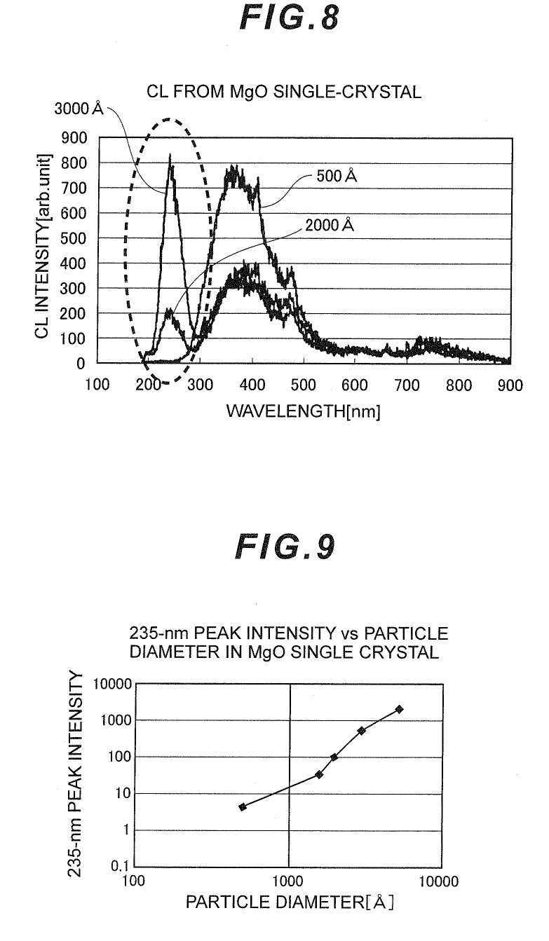

Specifically, because the crystalline MgO layer 5 is formed of an MgO single-crystal body produced by, for example, a vapor phase method or a liquid phase method as described earlier, as seen from FIG. 8 and FIG. 9, the exposure to the ultraviolet rays generated from the discharge gas by the discharge excites CL (and PL) emission having a peak within the 200-nm to 300-nm wavelength range (in particular, from 230 nm to 250 nm, around 235 nm) from the MgO single-crystal body included in the crystalline MgO layer 5, in addition to CL(and PL) emission having a peak within the 300-nm to 400-nm wavelength range.

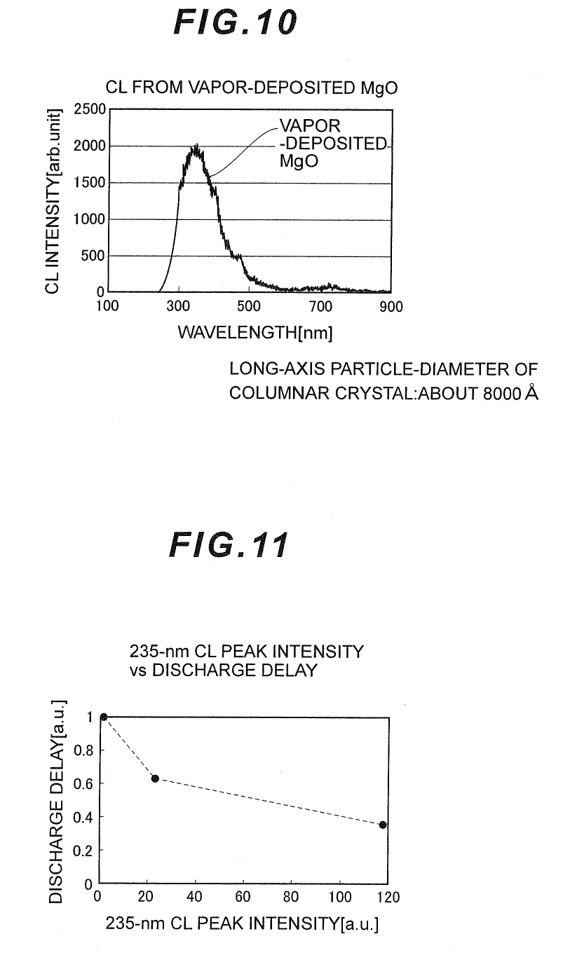

As shown in FIG. 10, CL (and PL) emission having the 235-nm peak wavelength is not excited from the MgO layer formed by the use of typical vapor deposition (corresponding to the thin-film MgO layer 4 in the example), but only CL emission with a peak wavelengths of from 300 nm to 400 nm is.

FIG. 10 shows the result of the measurement of CL (and PL) emission intensity relating to an evaporated MgO layer (film-thickness of about 8000 angstrom) of a polycrystal structure comprising columnar crystal with a particle diameter of 8000 angstrom in the long axis.

As seen from FIGS. 8 and 9, the greater the particle diameter of the MgO single-crystal body, the stronger the peak intensity of the CL (and PL) emission having a peak within a 200-nm to 300-nm wavelength range (particularly, 230 nm to 250 nm, around 235 nm). In turn, the stronger the peak intensity of the CL (and PL) emission having a peak within the 200-nm to 300-nm wavelength range, the greater the improvement in discharge characteristics such as those relating to discharge delay.

The above example employs an MgO single-crystal body having a particle diameter of 2000 angstrom or larger.

A conjectured reason why the crystalline MgO layer 5 causes the improvement of the discharge characteristics is that the MgO single-crystal body causing the CL (and PL) emission having a peak within the 200-nm to 300-nm wavelength range (particularly, 230 nm to 250 nm, around 235 nm) has an energy level corresponding to the peak wavelength, so that the energy level makes possible the trapping of electrons for a long time (some msec. or more), and the trapped electrons are extracted by an electric field so as to serve as the primary electrons required for starting a discharge.

The graph in FIG. 11 shows the correlationship between the intensity of the CL (and PL) emission and the discharge delay of the PDP. It is seen from FIG. 11 that the discharge delay in the PDP is shortened by the 235-nm CL (and PL) emission excited from the MgO crystal, and further, the stronger the intensity of the CL emission having the 235-nm peak, the more the discharge delay is shortened.

Next, a description will be given of the reason why the greater the particle diameter of the MgO single crystal, the stronger the intensity of the CL (and PL) emission having a peak within a 200-nm to 300-nm wavelength range (particularly, 230 nm to 250 nm, around 235 nm), and, in turn, why the stronger the intensity of the CL (and PL) emission, the greater the improvement in discharge characteristics offered by the MgO single-crystal body.

Specifically, in order to produce an MgO single crystal with a large particle diameter by use of a vapor phase method, an increase in the heating temperature for generating magnesium steam is required. This requirement increases the length of the flame with which magnesium and oxygen react, in turn increasing the temperature difference between the flame and the surrounding ambience. Thus, the larger the particle diameter of the MgO single-crystal body, the greater the number of energy levels occurring in correspondence with the peak wavelengths (e.g. within a range of from 230 nm to 250 nm, around 235 nm) of the CL (and PL) emission as described earlier.

It is estimated that in the case of an MgO single-crystal body of a cubic polycrystalline structure, many crystal-plane defects occur, and the presence of energy levels arising from these crystal plane defects contributes to an improvement in discharge probability.

Next, a description will be given of the reason why the powder of an MgO crystal body having 130 percent or higher of the ratio of the 146-nm emission intensity to the 172-nm emission intensity, which is included in the MgO crystal body forming the crystalline MgO layer 5, makes it possible to further improve the discharge delay in the operation of the PDP as compared with the cases of the conventional PDPs.

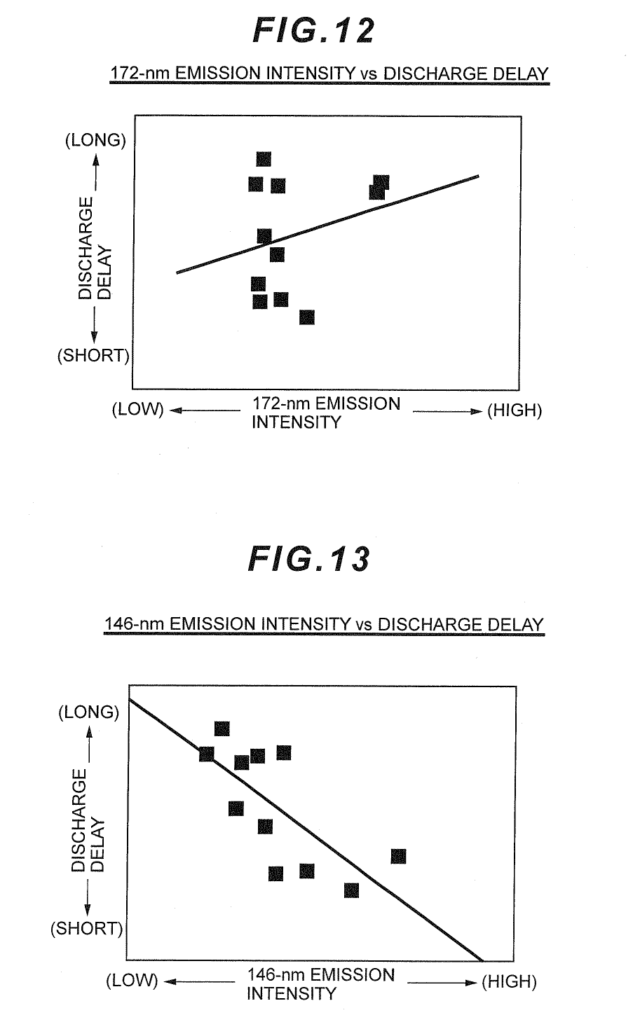

As described earlier, when an MgO crystal body, which has the properties of causing CL (and PL) emission having a peak within the 200-nm to 300-nm wavelength range upon excitation by ultraviolet rays, is situated in a position facing the discharge space in a PDP, the PDP is improved in its discharge characteristics because of the reduced discharged delay in the operation. However, as seen from FIG. 12 and FIG. 13, a greater improvement affecting discharge delay can be produced by CL (and PL) emission caused by the 146-nm wavelength ultraviolet light (resonance line) included among the vacuum ultraviolet rays generated from the discharge gas as a result of the discharge, than is produced by the CL (and PL) emission caused by the 172-nm wavelength ultraviolet light (molecular beam). This is because the 146-nm wavelength ultraviolet light produces an enhancement in primary electron emission properties.

An MgO crystal body having a high emission intensity ratio of the 146-nm emission intensity to the 172-nm emission intensity is one in which the layer causing CL (and PL) emission (the layer in which energy levels arising from these crystal plane defects are present) is located on the surface of the crystal. An MgO crystal body having a low emission intensity ratio is one in which the layer causing CL (and PL) emission is located inside the crystal body.

The ultraviolet light (molecular beam) at the 172-nm wavelength of the vacuum ultraviolet rays reaches the inside of the crystal, but the ultraviolet light (resonance line) at the 146-nm wavelength does not reach the inside of the crystal. For this reason, in a crystal body in which the layer causing CL (and PL) emission is located inside the crystal body, the 146-nm emission intensity is low, whereas in a crystal body in which the layer causing CL (and PL) emission is located on the surface of the crystal body, the 146-nm emission intensity is high.

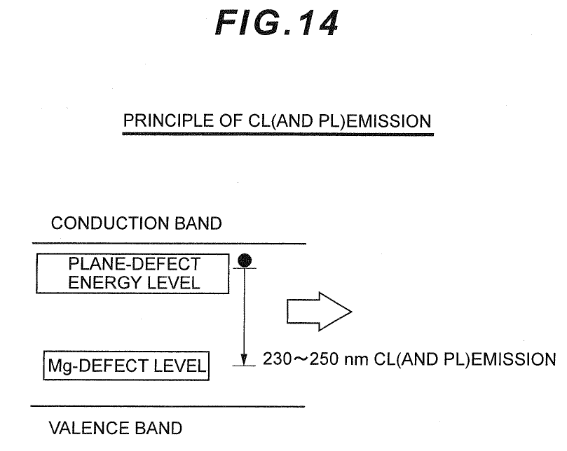

The reasons for this are here described. As illustrated in FIG. 14, CL (and PL) emission having a peak within the 200-nm to 300-nm wavelength range (in particular, from 230 nm to 250 nm, around 235 nm) is caused in the MgO crystal body by the emission of electrons from the MgO crystal body because of the energy trapped upon the transition of the electrons from the aforementioned plane-defect energy level in the conduction band to the magnesium-defect level in the valence band. For this reason, in a crystal body inside which the layer causing CL (and PL) emission is located, the number of magnesium-defect levels on the crystal surface is small, resulting in a low 146-nm emission intensity. By contrast, in a crystal in which the layer causing CL (and PL) emission is located on the surface of the crystal body, many magnesium-defect levels exist on the crystal surface, resulting in an increase in the energy trapped in the electron transition, thus increasing the 146-nm emission intensity.

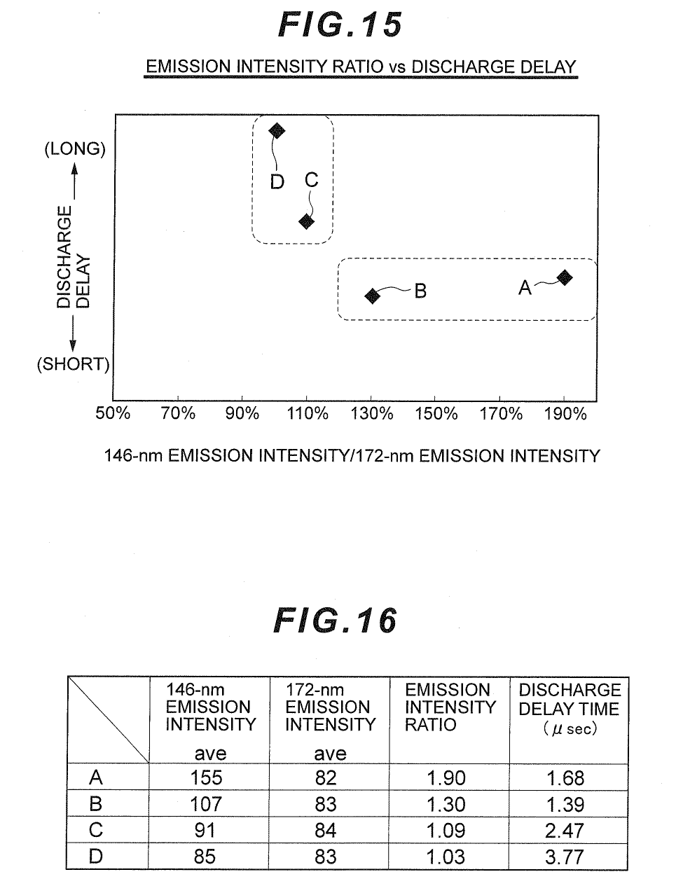

FIG. 15 is a graph showing the relationship between the discharge delay characteristics of the PDP and the emission intensity ratio of the 146-nm emission intensity to the 172-nm emission intensity of the MgO crystal body included in the crystalline MgO layer. FIG. 16 is a table showing the 146-nm emission intensity and the 172-nm emission intensity of the MgO crystal body in FIG. 15, the values of the ratio between the 146-nm emission intensity and the 172-nm emission intensity, and the discharge delay time of the PDP.

It is seen from FIG. 15 and FIG. 16 that the discharge delay characteristics of the PDP are improved by use of a crystalline MgO layer including a large amount of MgO crystal body with a higher 146-nm emission intensity than the 172-nm emission intensity. In particular, it is seen that when the emission intensity ratio of the 146-nm emission intensity to the 172-nm emission intensity becomes 130 or higher percent ((146-nm emission intensity)/(172-nm emission intensity)≧1.30), the discharge delay time in the operation of the PDP is significantly improved.

This ratio (emission intensity ratio) of the 146-nm emission intensity to the 172-nm emission intensity is a value obtained by measurements made on measuring condition as described below.

Specifically, for measurements of obtaining the emission intensity ratio, a ultraviolet lamp of wavelength 172 nm (hereinafter referred to as “172-nm UV lamp”) and a ultraviolet lamp of wavelength 146 nm (hereinafter referred to as “146-nm UV lamp”) were used to irradiate MgO crystal bodies with 172-nm wavelength ultraviolet ray and 146-nm wavelength ultraviolet ray. Then, PL emissions from the 172-nm UV-irradiated MgO crystal body and the 146-nm UV-irradiated MgO crystal body are received by a photodetector. Then, from the spectrum thus obtained, values of emission intensities on predetermined portions were calculated. Then, a value of the emission intensity ratio was calculated by use of an equation as described later.

An Xe excimer lamp (UEM 20 H-172, produced by Ushio Inc.) was used as the 172-nm UV lamp, and An Kr excimer lamp (UEM 20 H-146, produced by Ushio Inc.) was used as the 146-nm UV lamp. A CCD spectroscope (produced by Spectroscope Corporation) was used as the photodetector for the measurements relating to 146-nm emission and 172-nm emission.

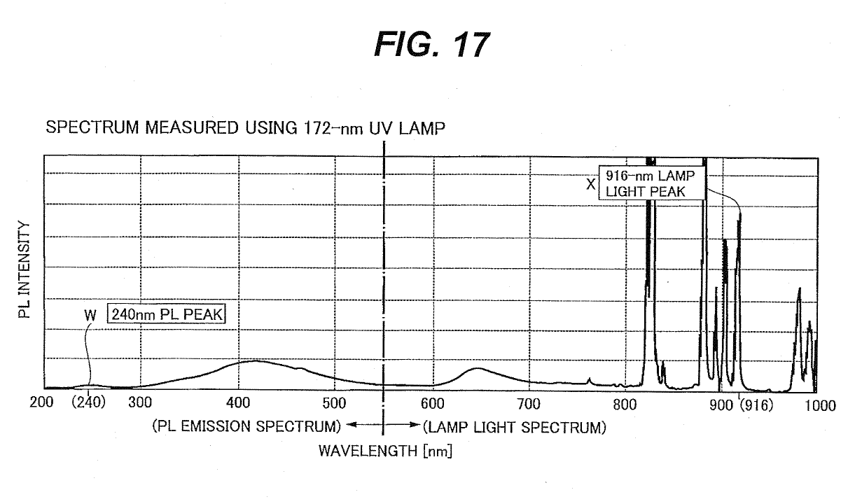

FIG. 17 shows the spectrum obtained by irradiating a MgO crystal body with 172-nm vacuum-ultraviolet light from the 172-nm UV lamp, and then receiving the PL emission from the MgO crystalline body by the CCD spectroscope.

The CCD spectroscope receives a red light output from the 172-nm UV lamp and the infrared component. For this reason, a portion roughly corresponding to 550-nm wavelength or higher in FIG. 17 shows the spectrum of the light output from the 172-nm UV lamp.

Reference letter W in FIG. 17 denotes the peak in the 240-nm wavelength position of the PL emission. The PL intensity at the peak W is hereinafter referred to as “240-nm PL intensity W”.

Likewise, reference letter X in FIG. 17 denotes the peak in the 916-nm wavelength position of the light output from the 172-nm UV lamp. The intensity of the light output from the 172-nm UV lamp at the peak X is hereinafter referred to as “172-nm UV lamp light intensity X”.

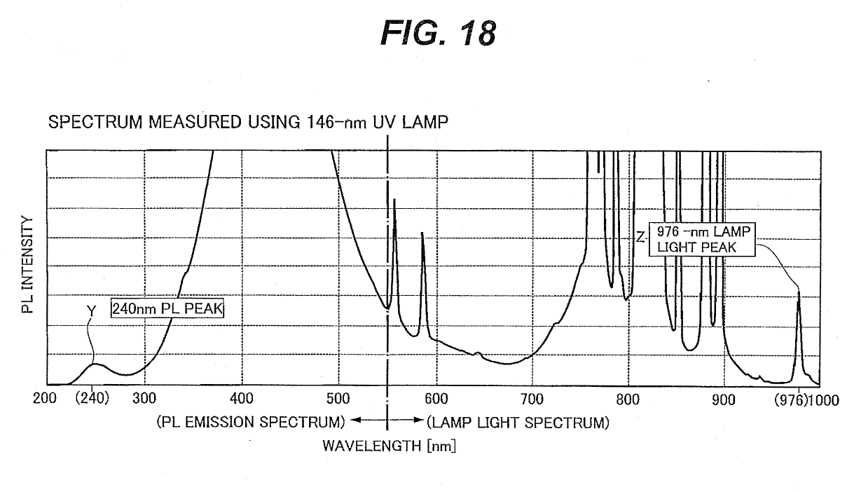

FIG. 18 shows the spectrum obtained by irradiating a MgO crystal body with 146-nm vacuum-ultraviolet light from the 146-nm UV lamp, and then receiving the PL emission from the MgO crystal body by the CCD spectroscope.

For the same reason as the case in FIG. 17, a portion roughly corresponding to 550-nm wavelength or higher in FIG. 18 shows the spectrum of the light output from the 146-nm UV lamp.

Reference letter Y in FIG. 18 denotes the peak in the position of 240-nm wavelength in the PL emission. The PL intensity at the peak Y is hereinafter referred to as “240-nm PL intensity Y”.

Likewise, reference letter Z in FIG. 18 denotes the peak in the 976-nm wavelength position of the light output from the 146-nm UV lamp. The intensity of the light output from the 146-nm UV lamp at the peak Z is hereinafter referred to as “146-nm UV lamp light intensity Z”.

An emission intensity ratio (146/172 ratio) is calculated from the intensity values in the peaks from point W to point Z read from the spectra in FIG. 17 and FIG. 18 by the following equation.

$$EmissionIntensityRatio = \frac{\begin{matrix}240 nm PLIntensityY \div \\ [ 146 nm UVLampLightIntensityZ \times 0.129 ]\end{matrix}}{\begin{matrix}240 nm PLintensity \div \\ [ 172 nm UVLampLightIntensityX \times 0.0317 ]\end{matrix}}$$

In the above equation, the denominator represents the 172-nm emission intensity and the numerator represents the 146-nm emission intensity.

In the 172-nm UV lamp, the peak intensity at 916 nm of the output light is used in place of the intensity of irradiation light. In the 146-nm UV lamp, the peak intensity at 976 nm of the output light is used in place of the intensity of irradiation light.

The reason is described. Essentially, the intensity of the 172-nm output light of the 172-nm UV lamp and the intensity of the 146-nm output light of the 146-nm UV lamp may simply be measured and respectively used as irradiation light intensities. However, because the CCD spectroscope which is the photodetector has a photoreceptor having a band ranging from 200 nm to 1000 nm, the intensities of the 172-nm output light and the 146-nm output light of the UV lamps cannot be measured.

In the above equation, the 172-nm UV lamp light intensity X is multiplied by a coefficient 0.0317, and the 146-nm UV lamp light intensity Z is multiplied by a coefficient 0.129. The reason is described. This is because, as a result of causing a difference in lamp light intensity between when the MgO crystal body is irradiated by use of the 172-nm UV lamp and when the it is irradiated by use of the 146-nm UV lamp, there is a need to eliminate the error of the effects of the MgO crystal body on the emission intensity between the denominator and the numerator which is cause by substituting, as the intensities of the irradiation light, the 916-nm peak intensity of the light output from the 172-nm UV lamp and the 976-nm peak intensity of the light from the 146-nm UV lamp into the aforementioned equation.

The following table shows an example of calculation in the aforementioned equation.

| | 146-nm emission | 172-nm emission |
|---|---|---|
| | intensity | intensity |
| 172-nm UV lamp light | — | 11457 |
| intensity X | | |
| 146-nm UV lamp light | 3270 | — |
| intensity Z | | |
| 240-nm PL intensity Y, W | 782 | 269 |
| Emission intensity | 1.85648318 | 0.741037936 |
| Emission intensity ratio | 251% | |
| (146/172 ratio) | | |

As described above, the PDP of the above example comprises the crystalline MgO layer 5 facing the discharge cells C. The crystalline MgO layer 5 includes an MgO crystal body that has the properties of causing CL (and PL) emission having a peak within the 200-nm to 300-nm wavelength range upon excitation by ultraviolet rays. In addition, the MgO crystal body forming the crystalline MgO layer 5 includes a large amount of an MgO crystal body with a higher 146-nm emission intensity than the 172-nm emission intensity. In particular, the powder of the MgO crystal body included has 130 percent or higher of the emission intensity ratio. As a result, the primary electron emission properties is enhanced by an increase in primary electrons emitted into the discharge cells C upon excitation by ultraviolet light (resonance line) at a 146-nm wavelength, which in turn makes it possible for the PDP to be significantly improved in its discharge delay characteristics in the PDP operation as compared with those of conventional PDPs.

The aforementioned example is of the case when an MgO crystal body with a higher 146-nm emission intensity than the 172-nm emission intensity is included in the crystalline MgO layer 5 that is deposited on the thin0film MgO layer 4 located closer to the front glass substrate 1, but is not limited to this. If an MgO crystal body with a higher 146-nm emission intensity than the 172-nm emission intensity is disposed in another position facing the discharge cell, it is also possible to significantly improve the discharge delay characteristics in the PDP operation as compared with those of conventional PDPs.

For example, when an MgO crystal body with a higher 146-nm emission intensity than the 172-nm emission intensity is included in the phosphor layer deposited on the back glass substrate and is exposed to the discharge cell, a significant improvement in the discharge delay characteristics in the PDP operation can be achieved.

The foregoing has described the example when the present invention applies to a reflection type AC PDP having a front glass substrate on which row electrode pairs are deposited and covered with a dielectric layer and a back glass substrate on which phosphor layers and column electrodes are formed. However, the present invention is applicable to various types of PDPs, such as a reflection-type AC PDP having row electrode pairs and column electrodes formed on the front glass substrate and covered with a dielectric layer, and having phosphor layers formed on the back glass substrate; a transmission-type AC PDP having phosphor layers formed on the front glass substrate, and row electrode pairs and column electrodes formed on the back glass substrate and covered with a dielectric layer; a three-electrode AC PDP having discharge cells formed in the discharge space in positions corresponding to the respective intersections between row electrode pairs and column electrodes; a two-electrode AC PDP having discharge cells formed in the discharge space in positions corresponding to the respective intersections between row electrodes and column electrodes.

The PDP according to the aforementioned example is described as an embodiment of basic concept of a PDP which comprises: a front substrate and a back substrate facing each other across a discharge space; row electrode pairs and column electrodes arranged between the front substrate and the back substrate to form unit light emission areas in positions in the discharge space respectively corresponding to intersections between the row electrode pairs and the column electrodes; and a dielectric layer covering the row electrode pairs, in which powder of a crystal body is disposed in positions facing the unit light emission areas, and the powder of the crystal body is included among a magnesium oxide crystal body having properties of causing cathode luminescence emission having a peak within a wavelength range of 200 nm to 300 nm upon excitation by ultraviolet rays, and has properties of having a higher intensity of light emission caused by ultraviolet light at 146-nm wavelength than an intensity of light emission caused by ultraviolet light at 172-nm wavelength.

Accordingly, in the PDP of the embodiment, the powder of MgO crystal body having the properties of having a higher intensity of light emission caused by ultraviolet light at 146-nm wavelength than that caused by ultraviolet light at 172-nm wavelength is disposed in positions facing the respective unit light emission areas formed in the discharge space. As a result, the primary electron emission properties are enhanced by an increase in primary electrons emitted into the unit light emission areas upon excitation by 146-nm wavelength ultraviolet light. In consequence, the PDP can be significantly improved in its discharge delay characteristics in the PDP operation.

While there has been described what are at present considered to be preferred embodiments of the present invention, it will be understood that various modifications may be made thereto, and it is intended that the appended claims cover all such modifications as fall within the true spirit and scope of the present invention.

What is claimed is:

1. A plasma display panel, comprising:
a front substrate and a back substrate facing each other across a discharge space;
row electrode pairs and column electrodes arranged between the front substrate and the back substrate to form unit light emission areas in positions in the discharge space respectively corresponding to intersections between the row electrode pairs and the column electrodes; and
a dielectric layer covering the row electrode pairs,
wherein powder of a crystal body is disposed in positions facing the unit light emission areas, is included among a magnesium oxide crystal body having properties of causing cathode luminescence emission having a peak within a wavelength range of 200 nm to 300 nm upon excitation by ultraviolet rays, and has properties of having a higher intensity of light emission caused by ultraviolet light at 146-nm wavelength than an intensity of light emission caused by ultraviolet light at 172-nm wavelength.

2. The plasma display panel according to claim 1, wherein the powder of the crystal body has 130 percent or higher of an emission intensity ratio of the intensity of light emission caused by the ultraviolet light at 146-nm wavelength to the intensity of light emission caused by the ultraviolet light at 172-nm wavelength.

3. The plasma display panel according to claim 1, wherein the powder of the crystal body has properties of causing cathode luminescence emission having a peak within a wavelength range of 230 nm to 250 nm.

4. The plasma display panel according to claim 1, wherein the powder of the crystal body includes a single-crystal body obtained by performing vapor-phase oxidization on magnesium steam generated by heating magnesium.

5. The plasma display panel according to claim 1, wherein a crystalline magnesium oxide layer including the powder of the crystal body is deposited on the dielectric layer and the powder of the crystal body of the crystalline magnesium oxide layer is exposed to the unit light emission areas.

6. The plasma display panel according to claim 5, wherein the crystalline magnesium oxide layer is deposited on a magnesium oxide layer of a thin film deposited on the dielectric layer by either vapor deposition or sputtering.

7. The plasma display panel according claim 1, wherein the powder of the crystal body is disposed in positions exposed to the unit light emission areas on the back substrate.

8. The plasma display panel according to claim 7, wherein the powder of the crystal body is included in phosphor layers deposited on the back substrate and arranged in the unit light emission areas.
